(19) United States
(12) Patent Application Publication
(10) Pub. No.: US 2026/0063980 A1
(43) Pub. Date: Mar. 5, 2026

(54) LIGHT SOURCE DEVICE AND PROJECTOR

(71) Applicant: SEIKO EPSON CORPORATION, Tokyo (JP)

(72) Inventor: Tomohiro YOKOO, MATSUMOTO-SHI (JP)

(21) Appl. No.: 19/313,458

(22) Filed: Aug. 28, 2025

(30) Foreign Application Priority Data
Aug. 30, 2024 (JP) 2024-148495

(51) Int. Cl. G03B 21/20; F21V 8/00; G03B 33/06

(52) U.S. Cl. CPC G03B 21/204; G02B 6/0025; G02B 6/0026; G02B 6/0031; G02B 6/0068; G02B 6/0076; G02B 6/0088; G02B 6/009; G03B 21/2013; G03B 33/06

(57) ABSTRACT

A light source device according to the present disclosure includes a first light source that emits first light, a wavelength conversion element that converts the first light into second light, a first optical member that transmits the first light and reflects the second light, a first light guide that guides the second light, a first reflecting member that reflects the first light and the second light, and a support member that supports the wavelength conversion element. The wavelength conversion element has a first surface on which the first light is incident, second and third surfaces crossing the first surface and facing opposite sides, and fourth and fifth surfaces crossing the first, second, and third surfaces and facing opposite sides. The first reflecting member is disposed at the second surface side of the wavelength conversion element and the first light guide, the second light is emitted from the third surface side of the first light guide, and the support member has a first support portion that supports the fourth surface and a second support portion that supports the fifth surface. The first optical member covers an opposite side to the wavelength conversion element of the first light guide disposed between the first support portion and the second support portion.

The present application is based on, and claims priority from JP Application Serial Number 2024-148495, filed Aug. 30, 2024, the disclosure of which is hereby incorporated by reference herein in its entirety.

### BACKGROUND

### 1. Technical Field

The present disclosure relates to a light source device and a projector.

### 2. Related Art

As a light source device used in a projector, there has been proposed a light source device using fluorescence emitted from a phosphor when the phosphor is irradiated with excitation light emitted from a light emitting element. WO 2006/054203 described below discloses a light source device including a wavelength conversion member that has a plate-like shape and includes a phosphor, and a light emitting diode that emits excitation light. In this light source device, out of a plurality of surfaces of the wavelength conversion member, the excitation light is caused to enter a plane of incidence large in area, and fluorescence is emitted from an exit surface small in area.

WO 2006/054203 is an example of the related art.

In the light source device disclosed in WO 2006/054203, the fluorescence generated inside the wavelength conversion member propagates through the interior of the wavelength conversion member by being totally reflected by interfaces between surfaces of the wavelength conversion member and an air layer, and is then emitted from the light exit surface. However, components of the fluorescence that are incident on the interfaces between the wavelength conversion member and the air layer at angles smaller than the critical angle are not totally reflected by the interfaces, and therefore leak to the outside via the interfaces before reaching the exit surface. There is therefore a problem of a decrease in the fluorescence use efficiency.

### SUMMARY

In order to solve the problems described above, a light source device according to one aspect of the present disclosure includes a first light source configured to emit first light in a first wavelength band, a wavelength conversion element configured to convert the first light into second light in a second wavelength band different from the first wavelength band, a first optical member disposed between the first light source and the wavelength conversion element and configured to transmit the first light and reflect the second light, a first light guide disposed between the wavelength conversion element and the first optical member and configured to guide the second light converted by the wavelength conversion element, a first reflecting member configured to reflect the first light and the second light, and a support member configured to support the wavelength conversion element, wherein the wavelength conversion element includes a first surface on which the first light is incident via the first optical member and the first light guide, a second surface and a third surface crossing the first surface and facing respective sides opposite to each other, and a fourth surface and a fifth surface crossing the first surface, the second surface, and the third surface and facing respective sides opposite to each other, the first reflecting member is disposed in a region at the second surface side of the wavelength conversion element and at the second surface side of the first light guide, the second light converted by the wavelength conversion element travels through the first light guide and is emitted from a region at the third surface side of the first light guide, the support member includes a first support portion configured to support the fourth surface of the wavelength conversion element and a second support portion configured to support the fifth surface of the wavelength conversion element, and the first optical member is in contact with the first support portion and the second support portion to cover an opposite side to the wavelength conversion member of the first light guide disposed between the first support portion and the second support portion.

A projector according to another aspect of the present disclosure includes the light source device according to the aspect of the present disclosure, a light modulation device configured to modulate light emitted from the light source device, and a projection optical device configured to project the light modulated by the light modulation device.

### BRIEF DESCRIPTION OF THE DRAWINGS

FIG. 1 is a schematic configuration diagram of a projector according to a first embodiment.

FIG. 2 is a side cross-sectional view showing a schematic configuration of a light source device.

FIG. 3 is a cross-sectional view viewed along the arrowed line III-III in FIG. 2.

FIG. 4 is a plan view of the light source device viewed from a +X side toward a −X side.

FIG. 5 is a cross-sectional configuration diagram of a light source device according to a second embodiment.

### DESCRIPTION OF EMBODIMENTS

### First Embodiment

A first embodiment of the present disclosure will hereinafter be described with reference to the drawings.

A projector according to the present embodiment is an example of a projector using liquid crystal panels as light modulation devices.

In the following drawings, elements are drawn at different dimensional scales in some cases in order to make the elements easier to view.

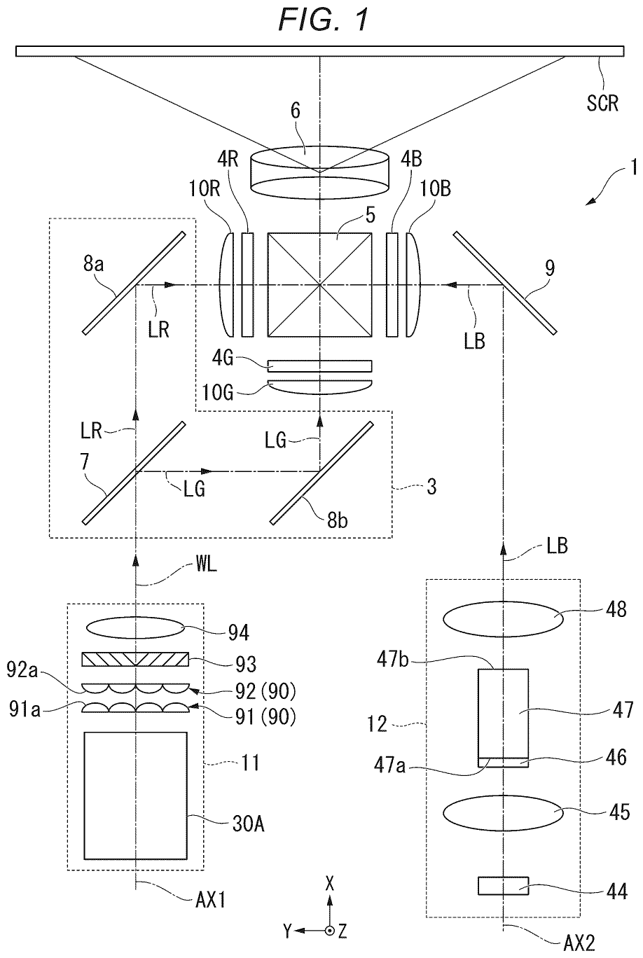

FIG. 1 is a schematic configuration diagram of a projector 1 according to the present embodiment.

As shown in FIG. 1, the projector 1 according to the present embodiment is a projection-type image display apparatus that displays a color image on a screen SCR as a projection target surface. The projector 1 includes three light modulation devices corresponding to colored light of red light LR, green light LG, and blue light LB, respectively.

The projector 1 includes a first illumination device 11, a second illumination device 12, a color separation optical system 3, a light modulation device 4R, a light modulation device 4G, a light modulation device 4B, a light combining element 5, and a projection optical device 6.

The first illumination device 11 emits yellow illumination light WL toward the color separation optical system 3. The second illumination device 12 emits the blue light LB toward the light modulation device 4B. Detailed configurations of the first illumination device 11 and the second illumination device 12 will be described later.

The description with reference to the drawings will hereinafter be presented using an X-Y-Z orthogonal coordinate system as needed. The Z axis is an axis extending along the vertical direction of the projector 1. The X axis is an axis parallel to an optical axis AX1 of the first illumination device 11 and an optical axis AX2 of the second illumination device 12. The Y axis is an axis perpendicular to the X axis and the Z axis. The optical axis AX1 of the first illumination device 11 is a central axis of fluorescence Y emitted from the first illumination device 11. The optical axis AX2 of the second illumination device 12 is a central axis of the blue light LB emitted from the second illumination device 12. One of two directions along the X axis is referred to as a +X direction, a direction opposite thereto is referred to as a −X direction, one of two directions along the Y axis is referred to as a +Y direction, a direction opposite thereto is referred to as a −Y direction, one of two directions along the Z axis is referred to as a +Z direction, and a direction opposite thereto is referred to as a −Z direction. Further, the two directions along the X axis are collectively referred to as an X-axis direction when not distinguished from each other, the two directions along the Y axis are collectively referred to as a Y-axis direction when not distinguished from each other, and the two directions along the Z axis are collectively referred to as a Z-axis direction when not distinguished from each other.

The color separation optical system 3 separates the yellow illumination light WL emitted from the first illumination device 11 into the red light LR and the green light LG. The color separation optical system 3 includes a dichroic mirror 7, a first reflecting mirror 8a, and a second reflecting mirror 8b.

The dichroic mirror 7 separates the illumination light WL into the red light LR and the green light LG. The dichroic mirror 7 transmits the red light LR and reflects the green light LG. The second reflecting mirror 8b is disposed in a light path of the green light LG. The second reflecting mirror 8b reflects, toward the light modulation device 4G, the green light LG reflected by the dichroic mirror 7. The first reflecting mirror 8a is disposed in a light path of the red light LR. The first reflecting mirror 8a reflects, toward the light modulation device 4R, the red light LR transmitted through the dichroic mirror 7.

Meanwhile, the blue light LB emitted from the second illumination device 12 is reflected by a reflecting mirror 9 toward the light modulation device 4B.

A configuration of the second illumination device 12 will hereinafter be described.

The second illumination device 12 includes a light source unit 44, a light collecting lens 45, a diffuser plate 46, a rod lens 47, and a relay lens 48. The light source unit 44 is configured with at least one semiconductor laser. The light source unit 44 emits the blue light LB as a laser beam. Note that the light source unit 44 is not necessarily configured with the semiconductor laser, and may be configured with an LED that emits blue light.

The light collecting lens 45 is configured with a convex lens. The light collecting lens 45 causes the blue light LB emitted from the light source unit 44 to enter the diffuser plate 46 in a substantially converged state. The diffuser plate 46 diffuses the blue light LB emitted from the light collecting lens 45 with a predetermined degree of diffusion to generate the blue light LB having a uniform light distribution substantially the same as that of the illumination light WL emitted from the first illumination device 11. A ground glass plate made of optical glass, for example, is used as the diffuser plate 46.

The blue light LB diffused by the diffuser plate 46 enters the rod lens 47. The rod lens 47 has a prismatic shape extending along the direction of the optical axis AX2 of the second illumination device 12. The rod lens 47 has an end plane of incidence of light 47a disposed at one end and a light exit end surface 47b disposed at the other end. The diffuser plate 46 is fixed to the end plane of incidence of light 47a of the rod lens 47 via an optical adhesive (not shown). It is desirable that the refractive index of the diffuser plate 46 matches as much as possible with the refractive index of the rod lens 47.

The blue light LB propagates through an interior of the rod lens 47 while being totally reflected to thereby be emitted from the light exit end surface 47b in a state in which the homogeneity of the illuminance distribution thereof is enhanced. The blue light LB emitted from the rod lens 47 enters the relay lens 48. The relay lens 48 causes the blue light LB, the homogeneity of the illuminance distribution of which is enhanced by the rod lens 47, to enter the reflecting mirror 9.

The light exit end surface 47b of the rod lens 47 has a rectangular shape substantially similar to the shape of an image formation region of the light modulation device 4B. Thus, the blue light LB emitted from the rod lens 47 is efficiently incident on the image formation region of the light modulation device 4B.

The light modulation device 4R modulates the red light LR in accordance with image information to form image light corresponding to the red light LR. The light modulation device 4G modulates the green light LG in accordance with the image information to form image light corresponding to the green light LG. The light modulation device 4B modulates the blue light LB in accordance with the image information to form image light corresponding to the blue light LB.

A transmissive liquid crystal panel, for example, is used for each of the light modulation devices 4R, 4G, and 4B. Further, polarization plates (not shown) are respectively disposed at the incident side and the exit side of the liquid crystal panel. The polarization plates each transmit only linearly polarized light polarized in a specific direction.

A field lens 10R is disposed at the incident side of the light modulation device 4R. A field lens 10G is disposed at the incident side of the light modulation device 4G. A field lens 10B is disposed at the incident side of the light modulation device 4B. The field lens 10R collimates a principal ray of the red light LR to be incident on the light modulation device 4R. The field lens 10G collimates a principal ray of the green light LG to be incident on the light modulation device 4G. The field lens 10B collimates a principal ray of the blue light LB to be incident on the light modulation device 4B.

When the image light emitted from the light modulation device 4R, the image light emitted from the light modulation device 4G, and the image light emitted from the light modulation device 4B enter the light combining element 5, the light combining element 5 combines the image light corresponding to the red light LR, the image light corresponding to the green light LG, and the image light corresponding to the blue light LB with one another to emit the combined image light toward the projection optical device 6. A cross dichroic prism, for example, is used for the light combining element 5.

The projection optical device 6 is configured with a plurality of projection lenses. The projection optical device 6 projects the image light combined by the light combining element 5 toward the screen SCR in an enlarged manner. Thus, a color image is displayed on the screen SCR.

Then, a configuration of the first illumination device 11 will be described.

The first illumination device 11 includes a light source device 30A, an integrator optical system 90, a polarization conversion element 93, and a superimposing optical system 94.

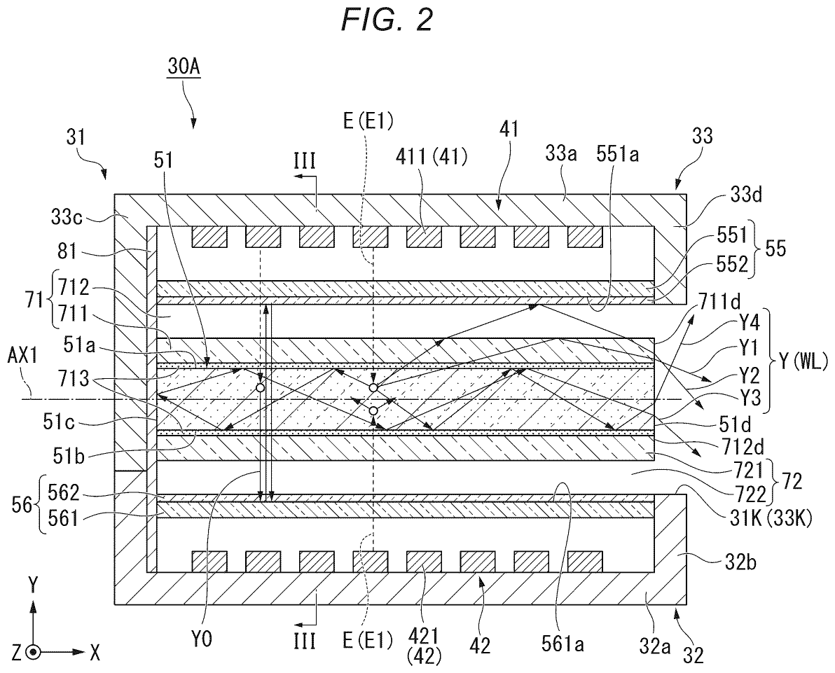

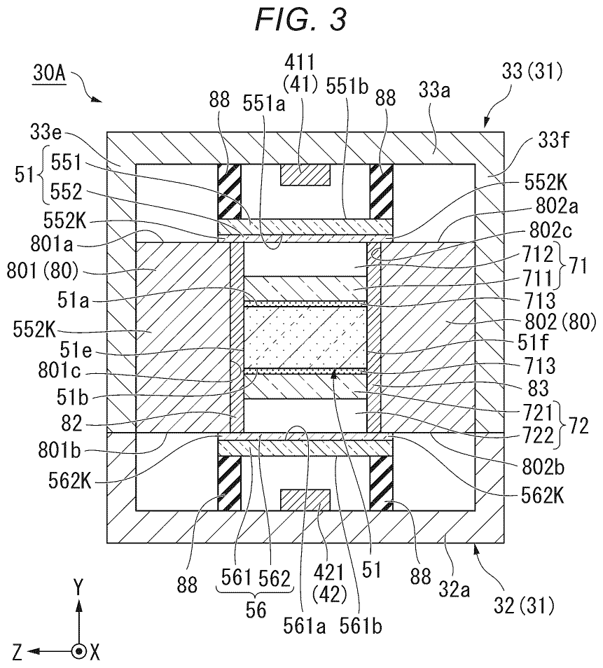

FIG. 2 is a side cross-sectional view showing a schematic configuration of the light source device 30A according to the present embodiment. FIG. 3 is a cross-sectional view viewed along the arrowed line III-III in FIG. 2.

As shown in FIG. 2, the light source device 30A according to the present embodiment includes a housing 31, a first light source 41, a second light source 42, a wavelength conversion element 51, a first optical member 55, a second optical member 56, a first light guide 71, a second light guide 72, a support member 80, a pressing member 88, a first reflecting member 81, a second reflecting member 82, and a third reflecting member 83.

The housing 31 constitutes an exterior of the light source device 30A. The housing 31 houses the first light source 41, the second light source 42, the wavelength conversion element 51, the first optical member 55, the first reflecting member 81, the second reflecting member 82, the third reflecting member 83, the second optical member 56, the first light guide 71, the second light guide 72, and the support member 80. The housing 31 is configured with a bottom plate portion 32 and a lid body 33.

The housing 31 has an extraction port 31K for extracting, to the outside, the yellow fluorescence Yand is emitted from the wavelength conversion element 51, the first light guide 71, and the second light guide 72 as the illumination light WL. The extraction port 31K is an opening defined by an opening 33K provided to a second sidewall portion 33d of the lid body 33 described later and a part of a frame portion 32b of the bottom plate portion 32. Note that the configuration of the extraction port 31K is not particularly limited, and a configuration in which the extraction port 31K is closed by a lid body made of a light-transmissive member to seal the inside of the housing 31 may be adopted.

The housing 31 is configured by arranging sidewall portions of the bottom plate portion 32 and the lid body 33 so as to abut each other. The lid body 33 and the bottom plate portion 32 are fixed to each other via a fixing member such as an adhesive or a screw, which are not shown. As described above, in the light source device 30A, elements such as the first light source 41, the second light source 42, the wavelength conversion element 51, the first optical member 55, the first reflecting member 81, the second reflecting member 82, the third reflecting member 83, the second optical member 56, the first light guide 71, the second light guide 72, and the support member 80 are housed in a space surrounded by the housing 31. This makes it possible to prevent foreign matter such as dust from adhering to the elements described above.

The bottom plate portion 32 has a substantially plate-like shape. The lid body 33 has a box-like shape that is open on one side, and has a top wall portion 33a, a first sidewall portion 33c, a second sidewall portion 33d, a third sidewall portion 33e, a fourth sidewall portion 33f, and an opening 33k.

The bottom plate portion 32 is disposed along the X-Z plane and has a recess that houses the second light source 42. The bottom plate portion 32 includes a base portion 32a and a frame portion 32b. The base portion 32a is a plate-shaped member forming a main body of the bottom plate portion 32 and is elongated in the X-axis direction. The frame portion 32b is integrated with the base portion 32a, and is disposed on a surface located at the +Y side of the base portion 32a.

The bottom plate portion 32 is coupled to the second light source 42 so as to be able to transfer heat. Accordingly, it is desirable for the bottom plate portion 32 to be formed of a material that has predetermined strength and is high in thermal conductivity. It is therefore desirable to use metal such as aluminum or stainless steel, in particular, an aluminum alloy such as a 6061-series aluminum alloy as the material of the bottom plate portion 32.

In the lid body 33, the top wall portion 33a is disposed along the X-Z plane and has a recess that houses the first light source 41. The first sidewall portion 33c and the second sidewall portion 33d cross the X axis along a longitudinal direction of the light source device 30A and are located at respective sides opposite to each other in the X-axis direction. The first sidewall portion 33c is located at the −X side, which is one side in the X-axis direction. The second sidewall portion 33d is located at the +X side, which is the other side in the X-axis direction. The third sidewall portion 33e and the fourth sidewall portion 33f are located at respective sides opposite to each other in the Z-axis direction, which crosses the longitudinal direction of the light source device 30A. In the present embodiment, the third sidewall portion 33e is located at the +Z side, which is one side in the Z-axis direction. The fourth sidewall portion 33f is located at the −Z side, which is the other side in the Z-axis direction.

The top wall portion 33a is coupled to the first light source 41 so as to be able to transfer heat. To this end, it is desirable for the lid body 33 to be formed of a material that has predetermined strength and is high in thermal conductivity similarly to the bottom plate portion 32. It is therefore desirable to use metal such as aluminum or stainless steel, in particular, an aluminum alloy such as a 6061-series aluminum alloy as the material of the lid body 33 similarly to the bottom plate portion.

The first light source 41 includes a plurality of first light emitting elements 411. The plurality of first light emitting elements 411 is each mounted on the top wall portion 33a of the housing 31. Note that the number of first light emitting elements 411 provided to the first light source 41 is not particularly limited.

The first light emitting elements 411 each emit an excitation light beam E1 in a first wavelength band. The first light emitting elements 411 are each configured with, for example, a light emitting diode (LED). The first light emitting elements 411 are each disposed to be facing the wavelength conversion element 51 to emit the excitation light beam E1 toward the wavelength conversion element 51. The first wavelength band is, for example, a violet-to-blue wavelength band ranging from 400 nm to 480 nm and has a peak wavelength of, for example, 445 nm. The plurality of first light emitting elements 411 is arranged along the X-axis direction, which is the longitudinal direction of the wavelength conversion element 51. In this way, the first light source 41 emits the excitation light E including the plurality of blue excitation light beams E1 toward the wavelength conversion element 51.

The second light source 42 is disposed at an opposite side to the first light source 41 with respect to the wavelength conversion element 51. The second light source 42 includes a plurality of second light emitting elements 421. The plurality of second light emitting elements 421 is respectively mounted on the recesses of the bottom plate portion 32 of the housing 31. Note that the number of second light emitting elements 421 provided to the second light source 42 is not particularly limited. The second light emitting elements 421 are each configured with the same light emitting element as the first light emitting element 411. Therefore, the second light source 42 emits the excitation light E including the plurality of blue excitation light beams E1 toward the wavelength conversion element 51.

The excitation light E in the present embodiment corresponds to an example of “first light” in the present disclosure.

The wavelength conversion element 51 has a columnar shape extending along the X axis and has six faces. Sides extending along the X axis of the wavelength conversion element 51 are longer than sides thereof extending along the Y axis and sides thereof extending along the Z axis. The X-axis direction corresponds to the longitudinal direction of the wavelength conversion element 51. The Y-axis direction is a direction parallel to the shortest side of the sides of the wavelength conversion element 51. The length of the sides along the Y axis is shorter than the length of the sides along the Z axis. That is, the cross-sectional shape of the wavelength conversion element 51 obtained by cutting the wavelength conversion element 51 with a plane along the Y-Z plane is a rectangular shape as shown in FIG. 3.

The wavelength conversion element 51 has a front surface 51a, a rear surface 51b, a first end surface 51c, a second end surface 51d, a first side surface 51e, and a second side surface 51f. The front surface 51a and the rear surface 51b cross the Y axis and face to respective sides opposite in the Y axis to each other. In the present embodiment, the front surface 51a is a surface located at the +Y side, which is one side in the Y-axis direction. The rear surface 51b is a surface located at the −Y side, which is the other side in the Y-axis direction. The excitation light E enters the front surface 51a from the first light source 41 provided to the top wall portion 33a via the first optical member 55 and the first light guide 71. The front surface 51a in the present embodiment corresponds to an example of a “first surface of the wavelength conversion element” in the present disclosure.

As illustrated in FIG. 2, the first end surface 51c and the second end surface 51d cross the front surface 51a and the rear surface 51b, and face to respective sides opposite to each other in the X-axis direction along the longitudinal direction of the wavelength conversion element 51. In the present embodiment, the first end surface 51c is located at the −X side, which is one side in the X-axis direction. The second end surface 51d is located at the +X side, which is the other side in the X-axis direction. The first end surface 51c in the present embodiment corresponds to an example of a “second surface of the wavelength conversion element” in the present disclosure, and the second end surface 51d in the present embodiment corresponds to an example of a “third surface of the wavelength conversion element”in the present disclosure.

As shown in FIG. 3, the first side surface 51e and the second side surface 51f cross the front surface 51a, the rear surface 51b, the first end surface 51c, and the second end surface 51d, and face to respective sides opposite in the Z-axis direction to each other. In the present embodiment, the first side surface 51e is located at the +Z side, which is one side in the Z-axis direction, and the second side surface 51f is located at the −Z side, which is the other side in the Z-axis direction. The first side surface 51e in the present embodiment corresponds to an example of a “fourth surface of the wavelength conversion element” in the present disclosure, and the second side surface 51f in the present embodiment corresponds to an example of a “fifth surface of the wavelength conversion element”in the present disclosure.

The wavelength conversion element 51 contains at least a yellow phosphor, and converts the excitation light E in the first wavelength band emitted from the first light source 41 and the second light source 42 into the yellow fluorescence Y and is in a second wavelength band different from the first wavelength band. Although details will be described later, a part of the yellow fluorescence Y generated inside the wavelength conversion element 51 is emitted from the front surface 51a to the first light guide 71, and another part of the fluorescence Y is emitted from the rear surface 51b to the second light guide 72.

The wavelength conversion element 51 contains a ceramic phosphor configured with a polycrystalline phosphor that performs wavelength conversion on the excitation light E into the fluorescence Y as yellow fluorescence. The wavelength conversion element 51 of the present embodiment is formed of a phosphor having no light scattering property, that is, a so-called transparent phosphor. The second wavelength band of the fluorescence Y as yellow fluorescence is a yellow wavelength band ranging, for example, from 490 to 750 nm. The center wavelength of the second wavelength band is, for example, 550 nm. That is, the fluorescence Y is yellow fluorescence containing a red light component and a green light component. The yellow fluorescence Y in the present embodiment corresponds to an example of “second light”in the present disclosure.

In the present specification, the transparent phosphor refers to, for example, a phosphor having a total light transmittance of 80% or higher with respect to fluorescence. The transparent phosphor that constitutes the wavelength conversion element 51 may be a transparent single crystal or a polycrystalline body having total light transmittance of 80% or higher, and examples of the transparent phosphor include a YAG-ceramic-based ceramic phosphor obtained by sintering a plurality of YAG phosphor particles.

The wavelength conversion element 51 made of such materials described above converts the excitation light E into the yellow fluorescence Y.

The wavelength conversion element 51 may contain a single-crystal phosphor in place of the polycrystalline phosphor. Alternatively, the wavelength conversion element 51 may be made of fluorescent glass. Alternatively, the wavelength conversion element 51 may be made of a material obtained by dispersing a large number of phosphor particles in a binder made of glass or resin. The wavelength conversion element 51 made of such materials described above converts the excitation light E into the yellow fluorescence Y.

Specifically, the material of the wavelength conversion element 51 contains, for example, an yttrium-aluminum-garnet-based (YAG-based) phosphor. Citing YAG:Ce, which contains cerium (Ce) as an activator, as an example, a material obtained by mixing raw powder materials containing elements such as Y₂O₃, Al₂O₃, or CeO₃, and then being subjected to a solid-phase reaction, Y—Al—O amorphous particles obtained by a wet method such as a coprecipitation method or a sol-gel method, or YAG particles obtained by a gas-phase method such as a spray-drying method, a flame heat decomposition method, or a thermal plasma method, and so on are used as a material of the wavelength conversion element 51.

As shown in FIG. 2, the first reflecting member 81 is disposed at the −X side of the first light source 41, the second light source 42, the wavelength conversion element 51, the first optical member 55, the second optical member 56, the first light guide 71, and the second light guide 72. The first reflecting member 81 is disposed in the first sidewall portion 33c of the lid body 33 and a part of the frame portion 32b of the bottom plate portion 32. Note that it is not necessary for the first reflecting member 81 to be disposed over the entire region described above, and it is sufficient for the first reflecting member 81 to be disposed in at least the region at the first end surface 51c side of the wavelength conversion element 51, the first optical member 55, the second optical member 56, the first light guide 71, and the second light guide 72.

The first reflecting member 81 reflects the fluorescence Y that has propagated through the wavelength conversion element 51, the first light guide 71, and the second light guide 72 to reach the first reflecting member 81. The first reflecting member 81 reflects the excitation light E that has propagated through the first light guide 71 and the second light guide 72 to reach the first reflecting member 81. That is, the first reflecting member 81 reflects the fluorescence Y and the excitation light E. The first reflecting member 81 is configured with, for example, a metal film, a dielectric multilayer film, or a scattering member containing barium sulfate.

As shown in FIG. 3, the wavelength conversion element 51 is supported by the support member 80 in the Z-axis direction. The support member 80 includes a first support portion 801 and a second support portion 802.

The first support portion 801 is provided to the third sidewall portion 33e of the lid body 33 to support the first side surface 51e described later in the wavelength conversion element 51. The second reflecting member 82 is provided on a surface at the wavelength conversion element 51 side of the first support portion 801. More specifically, the second reflecting member 82 is disposed on a side surface 801c of the first support portion 801, the side surface 801c being facing the first side surface 51e of the wavelength conversion element 51 and a region at the first side surface 51e side of the first light guide 71. The third sidewall portion 33e of the lid body 33 is coupled to the wavelength conversion element 51 via the support member 80 and the second reflecting member 82 so as to be able to transfer heat.

The second reflecting member 82 reflects the fluorescence Y and the excitation light E. The second reflecting member 82 includes, for example, a metal film, a dielectric multilayer film, or a scattering member.

Therefore, for example, the second reflecting member 82 reflects the excitation light E that has been transmitted through the wavelength conversion element 51, the first light guide 71, and the second light guide 72 and has reached the second reflecting member 82 to be incident on the wavelength conversion element 51. Thus, the conversion efficiency from the excitation light E into the fluorescence Y can be increased. Further, the second reflecting member 82 reflects the fluorescence Y that has been emitted from the wavelength conversion element 51, propagated through the first light guide 71 and the second light guide 72, and reached the second reflecting member 82. Thus, the extraction efficiency of the fluorescence Y can be increased.

The second support portion 802 is provided to the fourth sidewall portion 33f of the lid body 33 and supports the second side surface 51f described later in the wavelength conversion element 51. The third reflecting member 83 is disposed on a surface at the wavelength conversion element 51 side of the second support portion 802. More specifically, the third reflecting member 83 is disposed on the side surface 802c of the second support portion 802 that is facing the second side surface 51f of the wavelength conversion element 51 and a region at the second side surface 51f side of the second light guide 72. The fourth sidewall portion 33f of the lid body 33 is coupled to the wavelength conversion element 51 via the support member 80 and the third reflecting member 83 so as to be able to transfer heat.

Further, the third reflecting member 83 reflects the fluorescence Y and the excitation light E. The third reflecting member 83 includes, for example, a metal film, a dielectric multilayer film, or a scattering member.

Therefore, for example, the third reflecting member 83 reflects the excitation light E that has been transmitted through the wavelength conversion element 51, the first light guide 71, and the second light guide 72 and has reached the third reflecting member 83 to be incident on the wavelength conversion element 51. Thus, the conversion efficiency from the excitation light E into the fluorescence Y can be increased. Further, the third reflecting member 83 reflects the fluorescence Y that has been emitted from the wavelength conversion element 51, propagated through the first light guide 71 and the second light guide 72, and reached the third reflecting member 83. Thus, the extraction efficiency of the fluorescence Y can be increased.

As described above, according to the light source device 30 of the present embodiment, by efficiently releasing the heat of the wavelength conversion element 51 to the outside via the lid body 33, it is possible to suppress a rise in temperature of the wavelength conversion element 51 and suppress a decrease in the wavelength conversion efficiency due to a rise in temperature of the wavelength conversion element 51.

The first light guide 71 is supported by the first support portion 801 and the second support portion 802 via the second reflecting member 82 and the third reflecting member 83 in the Z-axis direction. Further, the first light guide 71 is disposed between the wavelength conversion element 51 and the first optical member 55 in the Y-axis direction and guides the fluorescence Y converted by the wavelength conversion element 51.

The first light guide 71 in the present embodiment includes a first light-transmissive member 711 and an air layer 712. The first light-transmissive member 711 is fixed to the front surface 51a of the wavelength conversion element 51 with a light-transmissive adhesive 713, and transmits the excitation light E and the yellow fluorescence Y. The air layer 712 is provided between the first light-transmissive member 711 and the first optical member 55.

According to the first light guide 71 in the present embodiment, since the first light-transmissive member 711 and the wavelength conversion element 51 are bonded to each other, there is no air layer between the first light-transmissive member 711 and the wavelength conversion element 51. Therefore, the fluorescence Y having been emitted from the wavelength conversion element 51 is less likely to be totally reflected at an interface with the first light-transmissive member 711, and therefore efficiently enters the first light-transmissive member 711. Therefore, the first light guide 71 can efficiently capture the fluorescence Y.

In the present embodiment, the refractive index of the first light-transmissive member 711 (1.4: quartz) is smaller than the refractive index of the wavelength conversion element 51 (1.7: YAG). The material of the first light-transmissive member 711 that satisfies this relationship is, for example, borosilicate acid glass such as BK7, synthetic quartz, or quartz crystal besides quartz. According to the configuration described above, the fluorescence Y is refracted when the fluorescence Y is incident on the first light-transmissive member 711 from the wavelength conversion element 51 to thereby decrease the angle of the fluorescence Y with the X axis along the longitudinal axis of the first light-transmissive member 711. That is, the fluorescence Y propagating through the interior of the first light-transmissive member 711 is incident on an end surface 711d at the second end surface 51d side perpendicular to the X axis at a small angle. Therefore, the first light-transmissive member 711 can efficiently extract the fluorescence Y from the end surface 711d at the second end surface 51d side.

Further, the thermal conductivity of the first light-transmissive member 711 is preferably higher than the thermal conductivity of the wavelength conversion element 51. The material of the first light-transmissive member 711 that satisfies this relationship is, for example, SiC, GaN, MgO, YAG, sapphire, or diamond. The first light-transmissive member 711 in the present embodiment is formed of, for example, quartz. According to the configuration described above, since the heat of the wavelength conversion element 51 is efficiently transferred to the first light-transmissive member 711 via the light-transmissive adhesive 713, the rise in temperature of the wavelength conversion element 51 can be suppressed. Accordingly, it is possible to suppress a decrease in light emission efficiency due to the rise in temperature of the wavelength conversion element 51.

The second light guide 72 is supported by the first support portion 801 and the second support portion 802 via the second reflecting member 82 and the third reflecting member 83 in the Z-axis direction. Further, the second light guide 72 is disposed between the wavelength conversion element 51 and the second optical member 56 to guide the fluorescence Y converted by the wavelength conversion element 51.

The second light guide 72 in the present embodiment includes a second light-transmissive member 721 and an air layer 722. The second light-transmissive member 721 is disposed by being bonded to the rear surface 51b of the wavelength conversion element 51 with a light-transmissive adhesive 713, and transmits the excitation light E and the yellow fluorescence Y. The air layer 722 is disposed between the second light-transmissive member 721 and the second optical member 56.

According to the second light guide 72 in the present embodiment, similarly to the first light guide 71, since there is no air layer between the second light-transmissive member 721 and the wavelength conversion element 51 and thus the total reflection of the fluorescence by the interface is suppressed, it is possible to efficiently capture the fluorescence Y into the second light-transmissive member 721.

Similarly to the first light-transmissive member 711, the second light-transmissive member 721 is made of a material lower in refractive index than the wavelength conversion element 51. Therefore, the second light-transmissive member 721 can efficiently extract the fluorescence Y from an end surface 721d at the second end surface 51d side. Further, similarly to the first light-transmissive member 711, the second light-transmissive member 721 is desirably made of a material higher in thermal conductivity than the wavelength conversion element 51. According to this configuration, since the heat of the wavelength conversion element 51 is efficiently transferred to the second light-transmissive member 721, it is possible to suppress the decrease in light emission efficiency due to the rise in temperature of the wavelength conversion element 51.

According to the light source device 30A of the present embodiment, since the air layer 712 having a large refractive index difference with respect to the first light-transmissive member 711 is disposed in the first light guide 71, it is possible to make it easy to totally reflect the fluorescence Y generated in the wavelength conversion element 51 by the interface between the first light-transmissive member 711 and the air layer 712. Further, also in the second light guide 72, by similarly disposing the air layer 722 having a large refractive index difference with respect to the second light-transmissive member 721, it is possible to make it easy to totally reflect the fluorescence Y generated in the wavelength conversion element 51 by the interface between the second light-transmissive member 721 and the air layer 722.

Therefore, according to the light source device 30A of the present embodiment, the fluorescence Y propagating in the second light-transmissive member 721 with the total reflection in the second light guide 72 can be emitted from the end surface 721d at the second end surface 51d side of the second light-transmissive member 721 while emitting the fluorescence Y propagating in the first light-transmissive member 711 with the total reflection in the first light guide 71 from the end surface 711d at the second end surface 51d side of the first light-transmissive member 711. Therefore, the extraction efficiency of the fluorescence Y can be improved.

The fluorescence Y transmitted through the first light-transmissive member 711 and emitted to the air layer 712 enters the first optical member 55.

The first optical member 55 is disposed between the first light source 41 and the wavelength conversion element 51. As illustrated in FIG. 3, the first optical member 55 is disposed on an upper surface 801a at the +Y side of the first support portion 801 and an upper surface 802a at the +Y side of the second support portion 802. Thus, the first optical member 55 covers an opposite side (+Y side) to the wavelength conversion element 51 of the first light guide 71 disposed between the first support portion 801 and the second support portion 802. The first optical member 55 transmits the excitation light E and reflects the fluorescence Y.

The first optical member 55 includes a first transparent substrate 551 and a first optical layer 552.

The first transparent substrate 551 is made of a light-transmissive material such as borosilicate glass such as BK7, quartz, synthetic quartz, quartz crystal, SiC, GaN, MgO, YAG, sapphire, or diamond. The first transparent substrate 551 needs to be made of a material capable of transmitting at least the excitation light E. The first transparent substrate 551 is shaped like a plate extending along the X axis. As shown in FIG. 3, a cross-sectional shape of the first transparent substrate 551 cut by a plane along the Y-Z plane is a rectangular shape, and is elongated in the X-axis direction.

The first optical layer 552 is formed of, for example, a dielectric multilayer film, and has an optical characteristic of transmitting the excitation light E and reflecting the fluorescence Y. The first optical layer 552 is deposited on a surface of the first transparent substrate 551. The first optical layer 552 is disposed between the wavelength conversion element 51 and the first transparent substrate 551. That is, the first optical layer 552 is disposed on a surface 551a at the side facing the wavelength conversion element 51 out of two surfaces of the first transparent substrate 551. According to this configuration, as described later, since the fluorescence Y is reflected by the first optical layer 552 without entering the first transparent substrate 551, a loss of the fluorescence Y due to the propagation inside the first transparent substrate 551 can be suppressed, and the use efficiency of the fluorescence Y can be increased.

The first optical member 55 is pressed against the support member 80 by the pressing member 88. The pressing member 88 is disposed between the first optical member 55 and the top wall portion 33a of the lid body 33 in the housing 31. The pressing member 88 is formed of an elastic member that generates a pressing force for pressing the first optical member 55 toward the support member 80. Note that as the elastic member constituting the pressing member 88, for example, a spring member or an elastomer can be used.

The pressing member 88 is in contact with a surface 551b at an opposite side to the first optical layer 552 out of the first transparent substrate 551 in the first optical member 55. According to this configuration, since the first optical layer 552 does not directly press the pressing member 88, a failure such as deformation or breakage due to an application of external force to the first optical layer 552 can be prevented from occurring.

In this way, the first optical member 55 covers the +Y side of the first light guide 71 sandwiched between the first support portion 801 and the second support portion 802 in the Z-axis direction. The width of the first optical member 55 in the Z-axis direction is larger than a gap generated between the first support portion 801 and the second support portion 802. That is, the first optical member 55 is disposed in a state of straddling an area between the first support portion 801 and the second support portion 802 in the Z-axis direction. Therefore, both ends of the first optical member 55 are disposed on the first support portion 801 and the second support portion 802.

Here, in the first optical member 55, since the first optical layer 552 is deposited on the entire surface of the first transparent substrate 551, it is difficult to uniformly deposit the first optical layer 552 up to end portions of the first transparent substrate 551. In addition, in the manufacturing process of the first optical member 55, a polishing treatment is performed on an end surface of the first transparent substrate 551 on which the first optical layer 552 is deposited, and on this case, the end surface of the first transparent substrate 551 is likely to be chipped, and there is a concern that a part of the first optical layer 552 may be chipped together with the end surface of the first transparent substrate 551. As described above, the end portion of the first optical layer 552 is regarded as a defective region where desired optical characteristics cannot be obtained due to a defect caused by a deposition failure or chipping.

In the light source device 30A according to the present embodiment, since the first optical member 55 straddles the area between the first support portion 801 and the second support portion 802, both ends of the first optical member 55, that is, the end portion of the first optical layer 552 corresponding to the defective region described above can be located outside the gap between the first support portion 801 and the second support portion 802. In the case of the present embodiment, the air layer 712 of the first light guide 71 is disposed in the gap at the +Y side between the first support portion 801 and the second support portion 802.

Further, in the case of the present embodiment, since the first optical layer 552 is in contact with the first support portion 801 and the second support portion 802, the defective region 552K of the first optical layer 552 and the air layer 712 located in the gap between the first support portion 801 and the second support portion 802 do not communicate with each other as shown in FIG. 3. Therefore, there is no chance for a part of the fluorescence Y propagating in the air layer 712 to enter the defective region 552K to thereby be leaked to the first light source 41 side to cause the loss. Therefore, the light use efficiency of the fluorescence Y can be improved by suppressing the light loss caused by the defective region 552K of the first optical layer 552.

The fluorescence Y transmitted through the second light-transmissive member 721 to be emitted to the air layer 722 enters the second optical member 56.

The second optical member 56 is disposed between the second light source 42 and the wavelength conversion element 51. As shown in FIG. 3, the second optical member 56 is disposed on a lower surface 801b at the −Y side of the first support portion 801 and a lower surface 802b at the −Y side of the second support portion 802. Thus, the second optical member 56 covers an opposite side (−Y side) to the wavelength conversion element 51 of the second light guide 72 disposed between the first support portion 801 and the second support portion 802. The second optical member 56 transmits the excitation light E and reflects the fluorescence Y.

The second optical member 56 includes a second transparent substrate 561 and a second optical layer 562.

Similarly to the first transparent substrate 551, the second transparent substrate 561 is made of a light-transmissive material such as borosilicate glass such as BK7, quartz, synthetic quartz, quartz crystal, SiC, GaN, MgO, YAG, sapphire, or diamond. The second transparent substrate 561 needs to be made of a material capable of transmitting at least the excitation light E. The second transparent substrate 561 is shaped like a plate extending along the X axis. As shown in FIG. 3, a cross-sectional shape of the second transparent substrate 561 cut by a plane along the Y-Z plane is a rectangular shape, and is elongated in the X-axis direction.

The second optical layer 562 is formed of a dielectric multilayer film similar to that of the first optical layer 552, and has an optical characteristic of transmitting the excitation light E and reflecting the fluorescence Y. The second optical layer 562 is disposed on a surface 561a at the side facing the wavelength conversion element 51 out of two surfaces of the second transparent substrate 561. According to this configuration, as described later, since the fluorescence Y is reflected by the second optical layer 562 without entering the second transparent substrate 561, a loss of the fluorescence Y due to the propagation inside the second transparent substrate 561 can be suppressed, and the use efficiency of the fluorescence Y can be increased.

Similarly to the first optical member 55, the second optical member 56 is pressed against the support member 80 by the pressing member 88. The pressing member 88 is disposed between the second optical member 56 and the top wall portion 33a of the lid body 33 in the housing 31. Since the pressing member 88 is in contact with a surface 561b at an opposite side to the second optical layer 562 out of the second transparent substrate 561 and does not directly press the second optical layer 562, deformation or breakage in the second optical layer 562 can be prevented from occurring.

Further, the second optical member 56 covers the −Y side of the second light guide 72 sandwiched between the first support portion 801 and the second support portion 802 in the Z-axis direction. The second optical member 56 is disposed in a state of straddling an area between the first support portion 801 and the second support portion 802 in the Z-axis direction, and both ends of the second optical member 56 are located on the first support portion 801 and the second support portion 802. Note that since the second optical member 56 has substantially the same configuration as the first optical member 55, it is considered that a defective region is also generated at the end portion of the second optical layer 562.

In the light source device 30A according to the present embodiment, since the second optical member 56 straddles the area between the first support portion 801 and the second support portion 802, the end portion of the second optical layer 562 corresponding to the defective region is located outside the gap between the first support portion 801 and the second support portion 802. In the case of the present embodiment, the air layer 712 of the first light guide 71 is disposed in the gap at the −Y side between the first support portion 801 and the second support portion 802.

Further, in the case of the present embodiment, since the second optical layer 562 is in contact with the first support portion 801 and the second support portion 802, a defective region 562K of the second optical layer 562 and the air layer 722 located in the gap between the first support portion 801 and the second support portion 802 do not communicate with each other as shown in FIG. 3. Therefore, there is no chance for a part of the fluorescence Y propagating in the air layer 722 to enter the defective region 562K to thereby be leaked to the second light source 42 side to cause the loss. Therefore, the light use efficiency of the fluorescence Y can be improved by suppressing the light loss caused by the defective region 562K of the second optical layer 562.

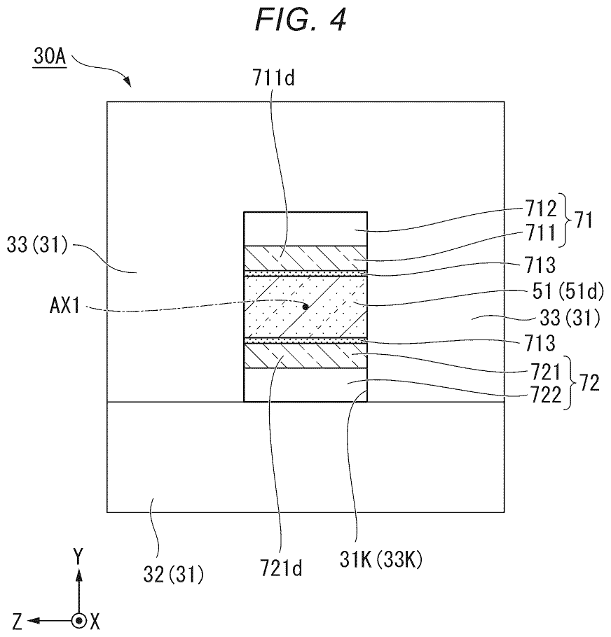

FIG. 4 is a plan view of the light source device 30A viewed from the +X side toward the −X side. That is, FIG. 4 is a plan view viewed in the X-axis direction, which is a normal direction of the second end surface 51d along the Y-Z plane in the wavelength conversion element 51. As shown in FIG. 4, the extraction port 31K overlaps the first light guide 71, the wavelength conversion element 51, and the second light guide 72. Therefore, the extraction port 31K of the housing 31 has a shape that exposes the first light guide 71, the wavelength conversion element 51, and the second light guide 72 to the inside.

The light source device 30A according to the present embodiment can extract the yellow fluorescence Y that has propagated through the first light guide 71, the wavelength conversion element 51, and the second light guide 72 via the extraction port 31K of the housing 31 to emit the fluorescence Y as the illumination light WL.

As shown in FIG. 1, the integrator optical system 90 is disposed at the light exit side of the light source device 30A. The integrator optical system 90 includes a first lens array 91 and a second lens array 92. The integrator optical system 90 functions as a homogeneous illumination optical system that homogenizes the intensity distribution of the illumination light WL emitted from the light source device 30A in each of the light modulation devices 4R, 4G, and 4B, which are each an illumination target region in cooperation with the superimposing optical system 94.

The first lens array 91 includes a plurality of first lenses 91a. The plurality of first lenses 91a is arranged in a matrix in a plane parallel to the Y-Z plane perpendicular to the optical axis AX1 of the first illumination device 11. The plurality of first lenses 91a divides the illumination light WL emitted from the light source device 30A into a plurality of partial luminous fluxes. The first lenses 91a each have a rectangular shape substantially similar to the shape of the image formation region of each of the light modulation devices 4R, 4G, and 4B. Thus, the partial luminous fluxes emitted from the first lens array 91 are each efficiently incident on the image formation region of each of the light modulation devices 4R, 4G, and 4B.

The illumination light WL emitted from the first lens array 91 travels toward the second lens array 92. The second lens array 92 is disposed so as to face the first lens array 91. The second lens array 92 includes a plurality of second lenses 92a corresponding to the plurality of first lenses 91a of the first lens array 91. The second lens array 92 forms images of the plurality of first lenses 91a of the first lens array 91 in the vicinity of the image formation region of each of the light modulation devices 4R, 4G, and 4B in cooperation with the superimposing optical system 94. The plurality of second lenses 92a is arranged in a matrix in a plane parallel to the Y-Z plane perpendicular to the optical axis AX1 of the first illumination device 11. The superimposing optical system 94 is configured with a single convex lens.

The first lenses 91a of the first lens array 91 and the second lenses 92a of the second lens array 92 have the same size as each other in the present embodiment, but may have respective sizes different from each other. Further, the first lenses 91a of the first lens array 91 and the second lenses 92a of the second lens array 92 are disposed at positions where the optical axes thereof coincide with each other in the present embodiment, but may be arranged in a state in which the optical axes thereof are shifted from each other.

The polarization conversion element 93 converts the polarization direction of the illumination light WL emitted from the second lens array 92. Specifically, the polarization conversion element 93 converts each of the partial luminous fluxes into which the illumination light WL is divided by the first lens array 91 and which are emitted from the second lens array 92 into linearly polarized light. The polarization conversion element 93 includes a polarization separation layer, a reflecting layer, and a retardation layer, which are not shown. The polarization separation layer transmits one linear polarization component of polarization components contained in the illumination light WL emitted from the light source device 30A without modification, and reflects the other linear polarization component thereof toward a direction perpendicular to the optical axis AX1. The reflecting layer reflects the other linear polarization component reflected by the polarization separation layer toward a direction parallel to the optical axis AX1. The retardation layer converts the other linear polarization component reflected by the reflecting layer into the one linear polarization component.

The behavior of the light in the light source device 30A according to the present embodiment will hereinafter be described.

As shown in FIG. 2, in the light source device 30A, the excitation light E emitted from the first light source 41 is transmitted through the first optical member 55 and the first light guide 71 to enter the wavelength conversion element 51. Further, the excitation light E emitted from the second light source 42 is transmitted through the second optical member 56 and the second light guide 72 to enter the wavelength conversion element 51. When the excitation light E enters the wavelength conversion element 51, the phosphor contained inside the wavelength conversion element 51 is excited, and the fluorescence Y is emitted from any light emission points in various directions.

Out of the fluorescence Y having been emitted from the wavelength conversion element 51, the fluorescence Y1 incident on the front surface 51a of the wavelength conversion element 51 at an incident angle smaller than the critical angle is emitted from the wavelength conversion element 51 and then enters the first light-transmissive member 711 of the first light guide 71.

Then, the fluorescence Y1 is incident on the interface between the first light-transmissive member 711 and the air layer 712 at an incident angle equal to or larger than the critical angle to thereby be totally reflected and is then emitted to the outside from the end surface 711d at the second end surface 51d side of the first light-transmissive member 711. Although not shown, a part of the fluorescence Y totally reflected by the interface between the first light-transmissive member 711 and the air layer 712 propagates in the first light-transmissive member 711 with total reflection, and is emitted to the outside from the end surface 711d at the second end surface 51d side of the first light-transmissive member 711.

Further, fluorescence Y2 having been emitted from the wavelength conversion element 51 enters the interface between the first light-transmissive member 711 and the air layer 712 at an incident angle smaller than the critical angle to thereby pass through the first light-transmissive member 711, and then enters the air layer 712. The fluorescence Y2 is reflected by the first optical layer 552 of the first optical member 55, transmitted through the air layer 712, incident on the first light-transmissive member 711 once again, and then emitted to the outside from the end surface 711d at the second end surface 51d side of the first light-transmissive member 711. Although not illustrated, a part of the fluorescence Y incident on the first light-transmissive member 711 once again propagates in the first light-transmissive member 711 with total reflection and is emitted to the outside from the end surface 711d at the second end surface 51d side.

Further, the fluorescence Y3 having been emitted from the wavelength conversion element 51 and having reached the first reflecting member 81 is reflected by the first reflecting member 81, then travels toward the +X side, then is reflected, for example, between the first optical layer 552 of the first optical member 55 and the first light-transmissive member 711 or the air layer 712 to thereby propagate through the inside of the first light guide 71, and is then emitted to the outside from the region at the second end surface 51d side of the first light guide 71.

Further, out of the fluorescence Y emitted from the wavelength conversion element 51, the fluorescence Y4 incident on the front surface 51a of the wavelength conversion element 51 at an incident angle equal to or larger than the critical angle is reflected by the front surface 51a and then guided inside the wavelength conversion element 51. In the case of the present embodiment, since the wavelength conversion element 51 is formed of a transparent phosphor, scattering of the fluorescence Y4 does not occur inside the wavelength conversion element 51, and the incident angle of the fluorescence Y4 with respect to the front surface 51a or the rear surface 51b of the wavelength conversion element 51 does not change. Therefore, the fluorescence Y4 traveling toward the +X side is repeatedly reflected between the front surface 51a and the rear surface 51b of the wavelength conversion element 51 and is then emitted from the second end surface 51d. Meanwhile, similarly to the fluorescence Y3, the fluorescence Y4 which travels toward the −X side is reflected by the first reflecting member 81, then travels toward the +X side, repeats reflection between the front surface 51a and the rear surface 51b of the wavelength conversion element 51, and is then emitted from the second end surface 51d.

In this way, the fluorescence Y having been emitted from the wavelength conversion element 51 repeats the reflection between the wavelength conversion element 51 or the first light-transmissive member 711 of the first light guide 71 and the first optical layer 552 of the first optical member 55 to thereby propagate through the interior of the first light-transmissive member 711 and the air layer 712, and is then emitted from the end surface 711d at the second end surface 51d side of the first light-transmissive member 711 and the region at the second end surface 51d side of the air layer 712.

In the present embodiment, the same applies to the behavior of the fluorescence Y incident at the second light guide 72 side directly from the wavelength conversion element 51 or indirectly via the first light guide 71 or the first optical member 55.

Therefore, in the light source device 30A according to the present embodiment, the fluorescence Y converted by the wavelength conversion element 51 travels through the wavelength conversion element 51 and the first light guide 71, and the second light guide 72, and is emitted from the second end surface 51d side of the wavelength conversion element 51 and the first light guide 71, and the second light guide 72. Therefore, according to the light source device 30A of the present embodiment, it is possible to efficiently extract the illumination light WL containing the fluorescence Y to the outside from the extraction port 31K of the housing 31.

It should be noted that in the case of the present embodiment, since the wavelength conversion element 51 is formed of the transparent phosphor, a traveling direction of fluorescence Y0 which is normally incident on the first optical layer 552 or the second optical layer 562 and is reflected perpendicularly out of the fluorescence Y emitted from the wavelength conversion element 51 is difficult to change while being transmitted through the inside of the wavelength conversion element 51, and the fluorescence Y0 is repeatedly reflected between the first optical layer 552 and the second optical layer 562 as shown in FIG. 2. As described above, the fluorescence Y0 repeatedly reflected between the first optical layer 552 and the second optical layer 562 is absorbed while propagating inside the wavelength conversion element 51 a plurality of times.

Since in the light source device 30A according to the present embodiment, the illumination light WL is extracted to the outside from the extraction port 31K of the housing 31, the etendue of the illumination light WL is small, so that an amount of illumination light WL lost in the optical members such as the integrator optical system 90 disposed in a posterior stage of the light source device 30A can be reduced. As a result, the use efficiency of the illumination light WL in the light source device 30A can be improved.

### Advantages of First Embodiment

The light source device 30A according to the present embodiment includes the first light source 41 that emits the excitation light E, the wavelength conversion element 51 that converts the excitation light E into the yellow fluorescence Y, the first optical member 55 disposed between the first light source 41 and the wavelength conversion element 51 to transmit the excitation light E and reflect the fluorescence Y, the first light guide 71 disposed between the wavelength conversion element 51 and the first optical member 55 to guide the fluorescence Y converted by the wavelength conversion element 51, the first reflecting member 81 that reflects the excitation light E and the fluorescence Y, and the support member 80 that supports the wavelength conversion element 51. The wavelength conversion element 51 has the front surface 51a on which the excitation light E is incident via the first optical member 55 and the first light guide 71, the first end surface 51c and the second end surface 51d that cross the front surface 51a and face respective sides opposite to each other, and the first side surface 51e and the second side surface 51f that cross the front surface 51a, the first end surface 51c, and the second end surface 51d and face respective sides opposite to each other. The first reflecting member 81 is disposed in a region at the first end surface 51c side of the wavelength conversion element 51 and at the first end surface 51c side of the first light guide 71. The fluorescence Y converted by the wavelength conversion element 51 travels through the first light guide 71 and is emitted from the region at the second end surface 51d side of the first light guide 71. The support member 80 has the first support portion 801 that supports the first side surface 51e of the wavelength conversion element 51 and the second support portion 802 that supports the second side surface 51f of the wavelength conversion element 51. The first optical member 55 is in contact with the first support portion 801 and the second support portion 802, and covers the opposite side to the wavelength conversion element 51 of the first light guide 71 disposed between the first support portion 801 and the second support portion 802.

Further, the light source device 30A according to the present embodiment further includes the second light source 42 disposed at the opposite side to the first light source 41 with respect to the wavelength conversion element 51 and configured to emit the excitation light E, the second optical member 56 disposed between the second light source 42 and the wavelength conversion element 51 and configured to transmit the excitation light E and reflect the fluorescence Y, and the second light guide 72 disposed between the wavelength conversion element 51 and the second optical member 56 and configured to guide the fluorescence Y converted by the wavelength conversion element 51. The fluorescence Y converted by the wavelength conversion element 51 travels through the second light guide 72 and is then emitted from the region at the second end surface 51d side of the second light guide 72. The second optical member 56 is in contact with the first support portion 801 and the second support portion 802, and covers the opposite side to the wavelength conversion element 51 of the second light guide 72 disposed between the first support portion 801 and the second support portion 802.

According to the light source device 30A of the present embodiment, the fluorescence Y generated by the wavelength conversion element 51 travels through the first light guide 71 and is then emitted from the end surface 711d at the second end surface 51d side of the first light-transmissive member 711 and the region at the second end surface 51d side of the air layer 712. Further, the fluorescence Y generated in the wavelength conversion element 51 travels through the second light guide 72 and is then emitted from the end surface 721d at the second end surface 51d side of the second light-transmissive member 721 and the region at the second end surface 51d side of the air layer 722.

Therefore, in the light source device 30A according to the present embodiment, the loss of the fluorescence Y is smaller and the use efficiency of the fluorescence Y can be increased compared to the related-art light source device in which the fluorescence is propagated through the wavelength conversion element only with the total reflection and is then extracted.

Further, in the light source device 30A according to the present embodiment, the first optical member 55 covers the opposite side of the first light guide 71 to the wavelength conversion element 51, and the second optical member 56 covers the opposite side of the second light guide 72 to the wavelength conversion element 51. Therefore, the defective region 552K generated in the end portion of the first optical layer 552 and the defective region 562K generated in the end portion of the second optical layer 562 do not communicate with the air layers 712, 722 located between the first support portion 801 and the second support portion 802. Therefore, it is prevented that a part of the fluorescence Y propagating through the air layer 712, 722 is incident on the defective region 552K, 562K to cause the light loss, and thus the light use efficiency of the fluorescence Y can be further increased.

Further, in the case of the present embodiment, since the air layers 712, 722 are exposed to the external space in the extraction port 31K and have no refractive index interface, the fluorescence Y, having reached the extraction port 31K through the air layers 712, 722, is emitted as it is to the external space without causing reflection or refraction. Therefore, since the first light guide 71 and the second light guide 72 include the air layers 712, 722, the extraction efficiency of the fluorescence Y can be increased.

The projector 1 according to the present embodiment includes the light source device 30A, the light modulation devices 4R, 4G, and 4B, which modulate the light emitted from the light source device 30A, and the projection optical device 6, which projects the light modulated by the light modulation devices 4R, 4G, and 4B.

According to the projector 1 of the present embodiment, since the first illumination device 11 including the light source device 30A efficiently extracting the illumination light WL containing the fluorescence Y is provided, the projector 1 is excellent in light use efficiency.

### Second Embodiment

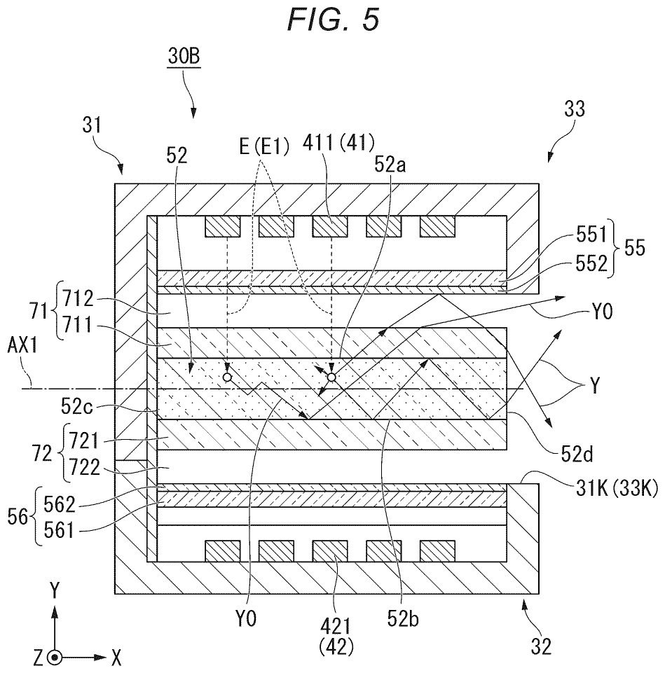

A second embodiment of the present disclosure will be described below with reference to FIG. 5.

The basic configuration of a light source device according to the second embodiment is substantially the same as that in the first embodiment, and therefore the description of the basic configuration of the light source device is omitted.

FIG. 5 is a cross-sectional view of a light source device 30B according to the second embodiment taken along the X-Y plane. In FIG. 5, elements common to those in the drawings used in the description of the first embodiment are denoted by the same reference symbols to omit the description thereof.

As shown in FIG. 5, the light source device 30B according to the present embodiment includes the housing 31, the first light source 41, the second light source 42, a wavelength conversion element 52, the first optical member 55, the second optical member 56, the first light guide 71, the second light guide 72, the support member 80, the pressing member 88, the first reflecting member 81, and the second reflecting member and the third reflecting member (not shown).

In the light source device 30A according to the first embodiment, the wavelength conversion element 51 is formed of the transparent phosphor. In contrast, in the light source device 30B according to the present embodiment, the wavelength conversion element 52 is formed of a phosphor having a light scattering property. The phosphor having a light scattering property can be realized by dispersing a medium different in refractive index from the transparent phosphor, for example, a scattering body such as gas pockets or fillers, in the transparent phosphor. The wavelength conversion element 52 has a front surface 52a, a rear surface 52b, a first end surface 52c and a second end surface 52d, and a first side surface 52e and a second side surface 52f.

The other configurations of the light source device 30B are substantially the same as those of the light source device 30A according to the first embodiment.

The front surface 52a, the first end surface 52c, the second end surface 52d, the first side surface 52e, and the second side surface 52f in the present embodiment correspond to examples of “the first surface, the second surface, the third surface, the fourth surface, and the fifth surface” of the present disclosure, respectively.

### Advantages of Second Embodiment

The present embodiment also provides the advantages substantially the same as those provided by the first embodiment such as the advantage that it is possible to realize the light source device 30B in which the fluorescence Y propagates through the light guide 71 and the second light guide 72 so that loss of the fluorescence Y is small and the use efficiency of the fluorescence Y is excellent or the advantage that it is possible to realize the light source device 30B which can efficiently emit the illumination light WL. In addition, it is possible to obtain substantially the same advantage as that of the first embodiment such as the advantage that it is possible to realize the light source device 30B in which a part of the fluorescence Y propagating through the air layers 712, 722 can be prevented from entering the defective regions 552K, 562K to further increase the use efficiency of the fluorescence Y.

In the case of the first embodiment, since the wavelength conversion element 51 is formed of the transparent phosphor, the traveling direction of the fluorescence Y0 (see FIG. 2) perpendicularly incident on the first optical layer 552 or the second optical layer 562 out of the fluorescence Y emitted from the wavelength conversion element 51 is difficult to change inside the wavelength conversion element 51, and the fluorescence Y0 is repeatedly reflected between the first optical layer 552 and the second optical layer 562, which results in a loss.

In contrast, in the case of the light source device 30B according to the present embodiment, since the wavelength conversion element 52 is formed of a phosphor having a light scattering property, a large amount of scattering occurs when the fluorescence Y reflected by the first optical layer 552 or the second optical layer 562 enters the wavelength conversion element 52 as shown in FIG. 5, and the traveling direction of the fluorescence Y changes each time the fluorescence Y is scattered.

Therefore, for example, even the fluorescence Y0 which is reflected by the first optical layer 552 and is then perpendicularly incident on the wavelength conversion element 52 is scattered in the wavelength conversion element 52 to be subjected to angle conversion, and then propagates through the first light guide 71 and is then emitted from the end surface 711d at the second end surface 51d side of the first light-transmissive member 711 and the region at the second end surface 51d side of the air layer 712. Alternatively, the fluorescence Y0 propagates through the second light guide 72 and is emitted from the end surface 721d at the second end surface 51d side of the second light-transmissive member 721 and the region at the second end surface 51d side of the air layer 722.

As described above, in the light source device 30B according to the present embodiment, the fluorescence Y propagates through the first light guide 71 while repeating at least one of the scattering by the wavelength conversion element 52, the reflection by the first optical layer 552 of the first optical member 55, and the reflection at the surface of the first light-transmissive member 711 in contact with the air layer 712, and is then emitted from the region at the second end surface 51d side of the first light guide 71. Further, the fluorescence Y propagates through the second light guide 72 while repeating at least one of the scattering by the wavelength conversion element 52, the reflection by the second optical layer 562 of the second optical member 56, and the reflection at the surface of the second light-transmissive member 721 in contact with the air layer 722, and is then emitted from the region at the second end surface 51d side of the second light guide 72.

In the case of the present embodiment, the fluorescence Y which propagates inside the wavelength conversion element 52 and is not emitted to the outside hardly exists. Therefore, according to the light source device 30B of the present embodiment, the fluorescence Y can more efficiently be extracted as the illumination light WL.

It should be noted that the wavelength conversion element 52 formed of the phosphor having the light scattering property is more likely to cause the reabsorption of the fluorescence Y transmitted through the inside compared to the wavelength conversion element 51 in the first embodiment formed of the transparent phosphor. Therefore, it is desirable that the dimension in the X-axis direction of the wavelength conversion element 52, which is the extraction direction of the fluorescence Y, is shorter than that of the wavelength conversion element 51 in the first embodiment. Note that the X-axis direction corresponds to the longitudinal direction of the wavelength conversion element 52.

According to the light source device 30B of the present embodiment, it is possible to increase the light use efficiency of the fluorescence Y while making the dimension in the longitudinal direction of the wavelength conversion element 52 shorter than that in the configuration of the first embodiment.

Therefore, the light source device 30B according to the present embodiment can realize a light source device in which the light use efficiency of the fluorescence Y is increased while the device configuration is reduced in size.

Note that the technical scope of the present disclosure is not limited to the embodiment described above, and various modifications can be made therein without departing from the spirit and scope of the present disclosure.

For example, in the embodiments described above, as the constituent material of the wavelength conversion element, it is possible to use, for example, a composite phosphor containing AlN and Ce: YAG. According to the configuration described above, even when the contact area between the wavelength conversion element and the housing is too small to secure a large number of heat dissipation paths, the thermal conductivity of the wavelength conversion element can be increased compared to when a phosphor made of Ce: YAG single body is used. This can increase the cooling efficiency of the wavelength conversion element. Accordingly, the maximum amount of the first excitation light can be increased, and the maximum output of the yellow fluorescence can be increased. Similarly, the wavelength conversion element may be configured with a composite phosphor.

Further, the light source devices according to the embodiments described above each include the second light source, but may each have a configuration including only the first light source. In this case, the second light guide 72 and the second optical member 56 may be omitted. In this case, a configuration in which the housing 31 supports the rear surface 52b of the wavelength conversion element 51 may be adopted.

Further, although both the first light guide and the second light guide of the light source device according to the embodiments described above are formed of the light-transmissive member and the air layer, at least one of the first light guide and the second light guide may be formed only of the air layer. Alternatively, at least one of the first light guide and the second light guide may be formed only of the light-transmissive member.

In addition, the specific descriptions of the shapes, the numbers, the arrangements, the materials, and the like of the elements of the light source device and the projector are not limited to those in the embodiments described above, and can be changed as appropriate. Further, in the embodiments described above, the example in which the light source device according to the present disclosure is installed in the projector using the liquid crystal panels is described, but this is not a limitation. The light source devices according to the present disclosure may each be applied to a projector using digital micromirror devices as the light modulation devices. Further, the projector is not required to include a plurality of light modulation devices, and may include just one light modulation device.

In the embodiments described above, an example in which the light source device according to the present disclosure is applied to the projector is described, but this is not a limitation. The light source device according to the present disclosure may be used for a lighting apparatus, a headlight of an automobile, and other components.

### Summary of Present Disclosure

The present disclosure will be summarized below as appendices.

### Appendix 1

A light source device including
a first light source configured to emit first light in a first wavelength band,
a wavelength conversion element configured to convert the first light into second light in a second wavelength band different from the first wavelength band,
a first optical member disposed between the first light source and the wavelength conversion element and configured to transmit the first light and reflect the second light,
a first light guide disposed between the wavelength conversion element and the first optical member and configured to guide the second light converted by the wavelength conversion element,
a first reflecting member configured to reflect the first light and the second light, and
a support member configured to support the wavelength conversion element, wherein
the wavelength conversion element includes a first surface on which the first light is incident via the first optical member and the first light guide, a second surface and a third surface crossing the first surface and facing respective sides opposite to each other, and a fourth surface and a fifth surface crossing the first surface, the second surface, and the third surface and facing respective sides opposite to each other,
the first reflecting member is disposed in a region at the second surface side of the wavelength conversion element and at the second surface side of the first light guide,
the second light converted by the wavelength conversion element travels through the first light guide and is emitted from a region at the third surface side of the first light guide,
the support member includes a first support portion configured to support the fourth surface of the wavelength conversion element and a second support portion configured to support the fifth surface of the wavelength conversion element, and
the first optical member is in contact with the first support portion and the second support portion to cover an opposite side to the wavelength conversion member of the first light guide disposed between the first support portion and the second support portion.

According to the light source device having this configuration, the second light generated by the wavelength conversion element travels through the first light guide and is emitted from the region at the third surface side of the first light guide. Therefore, in the light source device having this configuration, the loss of the second light is smaller and the use efficiency of the second light can be increased compared to the related-art light source device in which the second light is propagated through the wavelength conversion element only with the total reflection and is then extracted.

Further, in the light source device having this configuration, since the first optical member covers the opposite side of the first light guide to the wavelength conversion element, the defective region generated in the end portion of the first optical member does not communicate with the first light guide located between the first support portion and the second support portion. Therefore, since it is prevented that a part of the second light propagating in the first light guide is incident on the defective region to cause a light loss, the light use efficiency of the second light can be further increased.

### Appendix 2

The light source device according to Appendix 1, wherein
the first optical member includes a first transparent substrate configured to transmit the first light, and a first optical layer disposed on a surface at the wavelength conversion element side of the first transparent substrate and configured to transmit the first light, and reflect the second light.

According to this configuration, by providing the first optical layer to the transparent substrate shaped like a flat plate, the first optical layer can be formed of a flat film. In addition, since the second light is reflected by the first optical layer without entering the first transparent substrate, it is possible to suppress occurrence of a loss due to propagation of the second light in the first transparent substrate.

### Appendix 3

The light source device according to Appendix 1 or 2, wherein
the first light guide includes a first light-transmissive member disposed on the first surface of the wavelength conversion element and configured to transmit the first light and the second light, and
the second light converted by the wavelength conversion element propagates inside the first light-transmissive member and is emitted from an end surface at the third surface side of the first light-transmissive member.

According to this configuration, the refractive index difference between the wavelength conversion element and the light guide is small, and the critical angle on the interface between the wavelength conversion element and the light guide is small. Thus, it is easy to extract the second light generated by the wavelength conversion element to the first light guide, and it is possible to suppress the loss due to the reabsorption of the second light.

### Appendix 4

The light source device according to Appendix 3, wherein
the first light guide further includes an air layer provided between the first light-transmissive member and the first optical member, and
the second light converted by the wavelength conversion element propagates through an inside of the first light-transmissive member and the air layer and is then emitted from an end surface at the third surface side of the first light-transmissive member and a region at the third surface side of the air layer.

According to this configuration, since the second light is refracted when being emitted from the first light-transmissive member, the second light travels in a direction forming a small angle with the longitudinal direction of the wavelength conversion element. Further, since the air layer is exposed to the outside at the third surface side and has no refractive index interface, the second light having reached the region at the third surface side is emitted as it is to the external space without causing reflection or refraction. Therefore, the extraction efficiency of the second light can be increased.

### Appendix 5

The light source device according to Appendix 3 or 4, wherein
the first light-transmissive member and the first surface of the wavelength conversion element are fixed with a light-transmissive adhesive.

According to this configuration, since the first light-transmissive member and the wavelength conversion element are bonded to each other, there is no air layer between the first light-transmissive member and the wavelength conversion element. Therefore, the second light emitted from the wavelength conversion element is less likely to be totally reflected at the interface with the first light-transmissive member, and thus efficiently enters the first light-transmissive member. Therefore, the first light guide can efficiently capture the second light.

### Appendix 6

The light source device according to Appendix 3 or 4, wherein
a refractive index of the first light-transmissive member is smaller than a refractive index of the wavelength conversion element.

According to this configuration, since the second light is refracted when being incident on the first light-transmissive member from the wavelength conversion element, the angle of the second light with the longitudinal axis of the first light-transmissive member decreases. That is, the second light propagating through the interior of the first light-transmissive member is incident on the surface perpendicular to the longitudinal axis at a small angle. Therefore, the first light-transmissive member can efficiently extract the second light from the end surface at the third surface side.

### Appendix 7

The light source device according to any one of Appendices 1 to 6, further including
a housing configured to house the wavelength conversion element, the first optical member, and the support member, and
a pressing member disposed between the first optical member and the housing and configured to press the first optical member against the support member.

According to this configuration, it is possible to achieve a state in which an opposite side to the wavelength conversion element of the first light guide is covered in good condition by the first optical member being in contact with the support member.

### Appendix 8

The light source device according to any one of Appendices 1 to 7, further including
a housing configured to house the wavelength conversion element, the first optical member, and the support member, wherein
the housing includes an extraction port through which the second light emitted from a region at the third surface side of the first light guide is extracted to an outside, and
the extraction port overlaps the first light guide and the wavelength conversion element in a plan view in a normal direction of the third surface of the wavelength conversion element.

According to this configuration, the first optical member, the first light guide, the wavelength conversion element, and the first reflecting member can be protected by the housing, and the second light propagating inside the first light guide can be extracted to the outside through the extraction port of the housing as the illumination light.

### Appendix 9

The light source device according to any one of Appendices 1 to 8, further including
a second reflecting member and a third reflecting member configured to reflect the first light and the second light, wherein
the second reflecting member is disposed on a surface facing the fourth surface of the wavelength conversion element and a region at the fourth surface side of the first light guide in the first support portion, and
the third reflecting member is disposed on a surface facing the fifth surface of the wavelength conversion element and a region at the fifth surface side of the first light guide in the second support portion.

According to this configuration, the conversion efficiency from the first light to the second light can be increased by the second reflecting member and the third reflecting member. Further, it is possible to suppress the loss of the light caused by emitting the light from the fourth surface and the fifth surface and absorbing the light by the housing.

### Appendix 10

The light source device according to any one of Appendices 1 to 9, wherein
the wavelength conversion element is formed of a transparent phosphor.

According to this configuration, even when the wavelength conversion element made of the transparent phosphor is used, the light source device capable of efficiently extracting the second light to the outside from the third surface side of the first light guide can be realized.

### Appendix 11

The light source device according to any one of Appendices 1 to 9, wherein
the wavelength conversion element is formed of a phosphor having a light scattering property.

According to this configuration, the traveling direction of the second light is changed to various directions due to the scattering of the light by the wavelength conversion element, and it is possible to efficiently emit the second light propagating through the inside of the first light guide from the region at the third surface side. Therefore, the loss of the second light is suppressed, and the light extraction efficiency of the second light can further be increased.

### Appendix 12

The light source device according to Appendix 10, wherein
the wavelength conversion element includes a yellow phosphor,
the first light is blue light,
the second light is yellow fluorescence,
the first light guide includes a first light-transmissive member disposed on the first surface of the wavelength conversion element and configured to transmit the first light and the second light, and an air layer disposed between the first light-transmissive member and the first optical member, and
the fluorescence propagates through an inside of the first light-transmissive member and the air layer while repeating at least one of reflection by the wavelength conversion element, reflection by the first optical member, and reflection at a surface of the first light-transmissive member in contact with the air layer, and is emitted from an end surface at the third surface side of the first light-transmissive member and a region at the third surface side of the air layer.

According to this configuration, the yellow fluorescence generated by the wavelength conversion element can be efficiently extracted from the region at the third surface side of the first light guide.

### Appendix 13

The light source device according to Appendix 11, wherein
the wavelength conversion element includes a yellow phosphor,
the first light is blue light,
the second light is yellow fluorescence,
the first light guide includes a first light-transmissive member disposed on the first surface of the wavelength conversion element and configured to transmit the first light and the second light, and an air layer disposed between the first light-transmissive member and the first optical member, and
the fluorescence propagates through an inside of the first light-transmissive member and the air layer while repeating at least one of scattering by the wavelength conversion element, reflection by the first optical member, and reflection at a surface of the first light-transmissive member in contact with the air layer, and is emitted from an end surface at the third surface side of the first light-transmissive member and a region at the third surface side of the air layer.

According to this configuration, the wavelength conversion element can scatter the fluorescence.

### Appendix 14

The light source device according to any one of Appendices 1 to 13, further including,
a second light source disposed at an opposite side to the first light source with respect to the wavelength conversion element and configured to emit the first light,
a second optical member disposed between the second light source and the wavelength conversion element and configured to transmit the first light and reflect the second light, and
a second light guide disposed between the wavelength conversion element and the second optical member and configured to guide the second light converted by the wavelength conversion element, wherein
the second light converted by the wavelength conversion element travels through the second light guide and is emitted from a region at the third surface side of the second light guide, and
the second optical member is in contact with the first support portion and the second support portion to cover an opposite side to the wavelength conversion element of the second light guide disposed between the first support portion and the second support portion.

According to this configuration, since the second light generated by the wavelength conversion element travels through the second light guide and is emitted from the region at the third surface side of the second light guide, it is possible to further increase the light use efficiency of the second light. Further, since the second optical member covers the opposite side of the second light guide to the wavelength conversion element, the defective region generated in the end portion of the second optical member does not communicate with the second light guide located between the first support portion and the second support portion. Therefore, since it is prevented that a part of the second light propagating in the second light guide is incident on the defective region to cause a light loss, the light use efficiency of the second light can be further increased.

### Appendix 15

A projector including:
the light source device according to any one of Appendices 1 to 14;
a light modulation device configured to modulate light emitted from the light source device; and
a projection optical device configured to project the light modulated by the light modulation device.

According to the projector having this configuration, since the light source device configured to efficiently extract the light is provided, a projector excellent in light use efficiency can be provided.

What is claimed is:

1. A light source device comprising:
a first light source configured to emit first light in a first wavelength band;
a wavelength conversion element configured to convert the first light into second light in a second wavelength band different from the first wavelength band;
a first optical member disposed between the first light source and the wavelength conversion element and configured to transmit the first light and reflect the second light;
a first light guide disposed between the wavelength conversion element and the first optical member and configured to guide the second light converted by the wavelength conversion element;
a first reflecting member configured to reflect the first light and the second light; and
a support member configured to support the wavelength conversion element, wherein
the wavelength conversion element includes a first surface on which the first light is incident via the first optical member and the first light guide, a second surface and a third surface crossing the first surface and facing respective sides opposite to each other, and a fourth surface and a fifth surface crossing the first surface, the second surface, and the third surface and facing respective sides opposite to each other,
the first reflecting member is disposed in a region at the second surface side of the wavelength conversion element and at the second surface side of the first light guide,
the second light converted by the wavelength conversion element travels through the first light guide and is emitted from a region at the third surface side of the first light guide,
the support member includes a first support portion configured to support the fourth surface of the wavelength conversion element and a second support portion configured to support the fifth surface of the wavelength conversion element, and
the first optical member is in contact with the first support portion and the second support portion to cover an opposite side to the wavelength conversion member of the first light guide disposed between the first support portion and the second support portion.

2. The light source device according to claim 1, wherein
the first optical member includes a first transparent substrate configured to transmit the first light, and a first optical layer disposed on a surface at the wavelength conversion element side of the first transparent substrate and configured to transmit the first light, and reflect the second light.

3. The light source device according to claim 1, wherein
the first light guide includes a first light-transmissive member disposed on the first surface of the wavelength conversion element and configured to transmit the first light and the second light, and
the second light converted by the wavelength conversion element propagates inside the first light-transmissive member and is emitted from an end surface at the third surface side of the first light-transmissive member.

4. The light source device according to claim 3, wherein
the first light guide further includes an air layer provided between the first light-transmissive member and the first optical member, and
the second light converted by the wavelength conversion element propagates through an inside of the first light-transmissive member and the air layer and is then emitted from an end surface at the third surface side of the first light-transmissive member and a region at the third surface side of the air layer.

5. The light source device according to claim 3, wherein
the first light-transmissive member and the first surface of the wavelength conversion element are fixed with a light-transmissive adhesive.

6. The light source device according to claim 3, wherein
a refractive index of the first light-transmissive member is smaller than a refractive index of the wavelength conversion element.

7. The light source device according to claim 1, further comprising:
a housing configured to house the wavelength conversion element, the first optical member, and the support member; and
a pressing member disposed between the first optical member and the housing and configured to press the first optical member against the support member.

8. The light source device according to claim 1, further comprising
a housing configured to house the wavelength conversion element, the first optical member, and the support member, wherein
the housing includes an extraction port through which the second light emitted from a region at the third surface side of the first light guide is extracted to an outside, and
the extraction port overlaps the first light guide and the wavelength conversion element in a plan view in a normal direction of the third surface of the wavelength conversion element.

9. The light source device according to claim 1, further comprising
a second reflecting member and a third reflecting member configured to reflect the first light and the second light, wherein
the second reflecting member is disposed on a surface facing the fourth surface of the wavelength conversion element and a region at the fourth surface side of the first light guide in the first support portion, and
the third reflecting member is disposed on a surface facing the fifth surface of the wavelength conversion element and a region at the fifth surface side of the first light guide in the second support portion.

10. The light source device according to claim 1, wherein
the wavelength conversion element is formed of a transparent phosphor.

11. The light source device according to claim 1, wherein
the wavelength conversion element is formed of a phosphor having a light scattering property.

12. The light source device according to claim 10, wherein
the wavelength conversion element includes a yellow phosphor,
the first light is blue light,
the second light is yellow fluorescence,
the first light guide includes a first light-transmissive member disposed on the first surface of the wavelength conversion element and configured to transmit the first light and the second light, and an air layer disposed between the first light-transmissive member and the first optical member, and
the fluorescence propagates through an inside of the first light-transmissive member and the air layer while repeating at least one of reflection by the wavelength conversion element, reflection by the first optical member, and reflection at a surface of the first light-transmissive member in contact with the air layer, and is emitted from an end surface at the third surface side of the first light-transmissive member and a region at the third surface side of the air layer.

13. The light source device according to claim 11, wherein
the wavelength conversion element includes a yellow phosphor,
the first light is blue light,
the second light is yellow fluorescence,
the first light guide includes a first light-transmissive member disposed on the first surface of the wavelength conversion element and configured to transmit the first light and the second light, and an air layer disposed between the first light-transmissive member and the first optical member, and
the fluorescence propagates through an inside of the first light-transmissive member and the air layer while repeating at least one of scattering by the wavelength conversion element, reflection by the first optical member, and reflection at a surface of the first light-transmissive member in contact with the air layer, and is emitted from an end surface at the third surface side of the first light-transmissive member and a region at the third surface side of the air layer.

14. The light source device according to claim 1, further comprising:
a second light source disposed at an opposite side to the first light source with respect to the wavelength conversion element and configured to emit the first light;
a second optical member disposed between the second light source and the wavelength conversion element and configured to transmit the first light and reflect the second light; and
a second light guide disposed between the wavelength conversion element and the second optical member and configured to guide the second light converted by the wavelength conversion element, wherein
the second light converted by the wavelength conversion element travels through the second light guide and is emitted from a region at the third surface side of the second light guide, and
the second optical member is in contact with the first support portion and the second support portion to cover an opposite side to the wavelength conversion element of the second light guide disposed between the first support portion and the second support portion.

15. A projector comprising:
the light source device according to claim 1;
a light modulation device configured to modulate light from the light source device; and
a projection optical device configured to project the light modulated by the light modulation device.
